(19) United States
(12) Patent Application Publication
(10) Pub. No.: US 2009/0028679 A1
(43) Pub. Date: Jan. 29, 2009

(54) DEVICE, SYSTEM AND METHOD FOR LOAD TRANSPORT

(76) Inventor: Stephen M. Smith, York, ME (US)

Correspondence Address: MESMER & DELEAULT, PLLC, 1 NEW HAMPSHIRE AVE., SUITE 125, PORTSMOUTH, NH, 03801, US

(21) Appl. No.: 12/171,522

(22) Filed: Jul. 11, 2008

Related U.S. Application Data
(60) Provisional application No. 60/961,919, filed on Jul. 25, 2007.

(51) Int. Cl. B60P 9/00

(52) U.S. Cl. 414/462; 414/800

(57) ABSTRACT

A load transport device that mounts to a vehicle mounted trailer hitch. The load transport system comprises a channel portion fitted with a pinion gear, and the channel portion is rigidly attached to a mounting bar that slideably engages a receiver portion of a vehicle's trailer hitch. The device also comprises an invertible shaft with an optionally-motorized rack gear system. The invertible shaft has a channel portion insertion end and a load lifting end. The invertible shaft slideably engages in either a load-low or load-high orientation depending on which end, the insertion end or the load lifting end first engages with the channel portion. The pinion gear and the rack gear system are functionally engaged. The load transport device further comprises a load support member attached to the load lifting end and comprising one or more bars that support a load.

### BACKGROUND

1. Field of the Invention

The present invention relates generally to the field of load transport devices and more particularly to a multipurpose, invertible load transport device that mounts to a vehicle mounted trailer hitch for accommodating disparate types of loads for transport.

2. Discussion of Background Information

Transport devices that mount to a vehicle's exterior are well known in the art. These devices generally mount to a vehicle's roof rack or rear mounted trailer hitch.

Roof rack transport devices usually comprise a lidded compartment for storing loose items therein. These devices, which anchor to a vehicle's roof rack with ties and clips, are useful for transporting sports equipment and luggage, but they are undesirable for a number of reasons. First, they are cumbersome to install and difficult after installation because they require users to reach overhead or balance on a vehicle's side running boards while attaching the device, and adding and arranging content. Second, these overhead storage bins are useful only for transporting certain items as prescribed by limited interior space. A bicycle with pedals attached, for example, will be too wide to allow the compartment's lid to close securely. Third, once affixed to a vehicle, these devices remain affixed, requiring emptying of their contents at the vehicle's location. Again, this requires users to reach overhead to retrieve items before manually transporting them to their final destination. Lastly, these devices provide added wind resistance to a vehicle, reducing economy by consuming more fuel when maintaining a standard rate of speed.

Other types of load transport devices mount to a vehicle's trailer hitch and similarly may provide a lidded compartment for storing loose articles such as luggage, sports equipment and waste. Most trailer hitch mounted transport devices, however, are devices providing protrusions for retaining and suspending sports equipment, such as bicycles, kayaks, and skis, at a safe height above a roadway. These devices are effective for that limited purpose, but fail to provide a means for transporting other loose items requiring containment in a cargo bin. Additionally, when loaded, these devices generally prevent or impede opening a rear door of a vehicle.

Some trailer hitch mounted cargo bins exist as well. These load transport bins, however, are cumbersome and generally provide drawbacks similar to those of the roof rack mounted cargo bins. These trailer hitch mounted bins enable easier access, but they also provide limited utility, provide no easy means of detachment from the vehicle, and generally require unloading at the vehicle rather than at a final destination.

Additionally, purchasing more than one of these limited-purpose transport devices accrues expense. Buying a cargo bin for transporting smaller, loose items and a separate trailer hitch mounted transport device for securing skis or bicycles may be infeasible for most people. Even if a purchaser can afford to acquire multiple types of transport devices, having to mount and dismount different types of devices from a vehicle certainly is an inconvenience.

Although various types of vehicle mounted load transport devices exist for securing and transporting particular types of otherwise loose paraphernalia to a vehicle's exterior, a need exists for a cost effective, easily accessible, multifunctional load transport device that enables transport of all types of loose items, allows for easy accessibility and optionally engages with a detachable, transportable cargo container.

### SUMMARY OF THE INVENTION

The present invention is directed to an improved load transport device that mounts to a vehicle mounted trailer hitch. The load transport system comprises a channel portion fitted with a pinion gear, and the channel portion is rigidly attached to a mounting bar that slideably engages a receiver portion of a vehicle's trailer hitch. The device also comprises an invertible shaft with a rack gear system. The invertible shaft has a channel portion insertion end and a load lifting end. The invertible shaft slideably engages in either a load-low or load-high orientation depending on which end, the insertion end or the load lifting end, first engages with the channel portion. The pinion gear of the channel portion and the rack gear system of the invertible shaft are functionally engaged. The load transport device further comprises a load support member attached to the load lifting end that comprises one or more bars for supporting a load. The one or more bars may be adapted for engagement with one or more channels of a frame portion that supports a load receptacle, or the load support member may be adapted for carrying loose items, such as sports equipment.

The present invention also provides a method of using a load transport device adapted for mounting to a vehicle mounted trailer hitch. The method comprises providing a channel portion fitted with a pinion gear and rigidly attached to a mount bar that slideably engages a receiver portion of a trailer hitch. The method also comprises providing an invertible shaft with a rack gear system thereon, the invertible shaft having a channel portion insertion end and a load lifting end. The method further comprises slideably engaging the invertible shaft with the channel portion in a load-low or load-high orientation such that the pinion gear and the rack gear system functionally engage. The method also comprises the step of engaging the channel portion with the receiver portion of the trailer hitch.

### BRIEF DESCRIPTION OF THE DRAWINGS

These and other features, aspects, and advantages of the present invention will become better understood with reference to the following description, appended claims, and accompanying drawings where:

FIG. 1 shows a perspective view of one embodiment of the present invention in relation to a vehicle.

FIG. 2 shows a perspective exploded view of one embodiment of the present invention in relation to a framed load.

FIG. 3 shows a perspective exploded view of another embodiment of the present invention in relation to a framed load.

FIG. 4 shows a perspective view of another embodiment of the present invention.

FIG. 5 shows a swing arm feature of one embodiment of the present invention.

FIG. 6 shows another view of the swing arm feature of one embodiment of the present invention.

### DETAILED DESCRIPTION

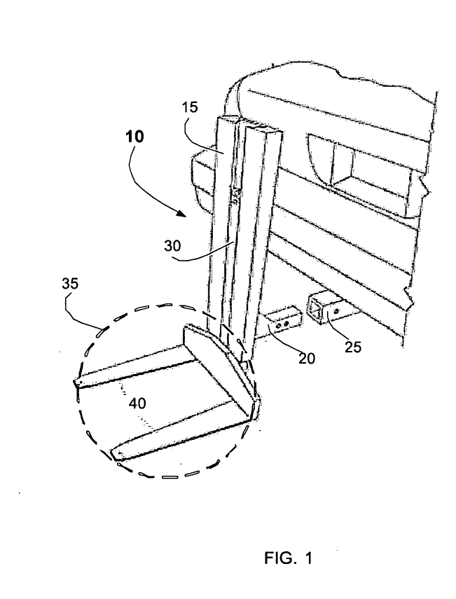

Referring now to FIG. 1, one embodiment of a load transport device 10 comprises a channel portion 15 that is rigidly attached to a mounting bar 20 that slideably engages with a receiver portion 25 of a vehicle trailer hitch. The load transport device 10 also comprises an invertible shaft 30 that slideably engages with the channel portion 15 in a load-low or load-high orientation. Here, the invertible shaft and a load support member 35 extending therefrom are in a load-low orientation because the load support member 35 rides low on the channel portion 15. The load support member 35 may comprise one or more bars 40 and in the embodiment of FIG. 1, the load support member 35 comprises two bars 40, for supporting a load (not shown).

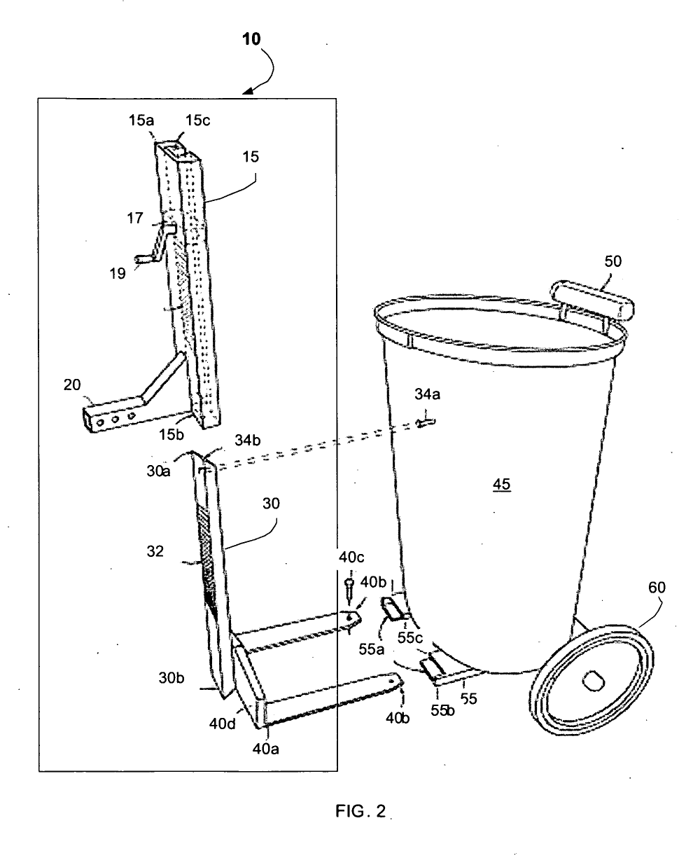

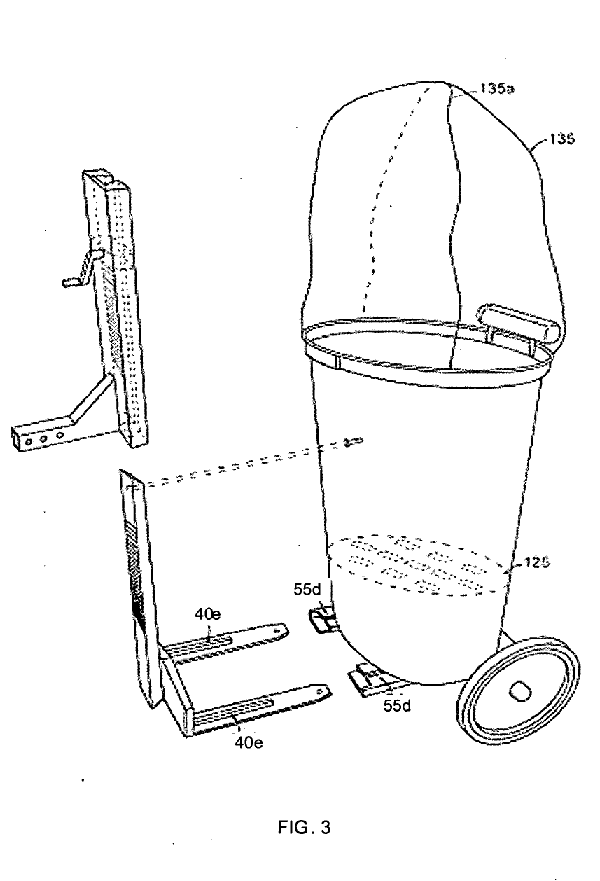

FIG. 2 depicts the embodiment of the load transport device 10 of FIG. 1 in greater detail and in relation to a load receptacle 45 which comprises a telescoping handle 50, an integrated support frame portion 55, and a set of detachable and/or foldable wheels 60 for easily transporting the load receptacle 45 to a final location for unloading. The supporting frame portion 55 may further comprise a plurality of channels 55a for receiving the one or more bars 40. The plurality channels 55a may have partial or fully extended sidewalls 55c for more securely retaining the one or more bars 40. In an alternate embodiment depicted in FIG. 3, the one or more bars 40 may comprise a protruding member 40e which interlocks with the plurality of channels 55a for better alignment during engagement and added stability during load transport.

Other geometric shapes are applicable to the one or more load bars 40 and the plurality of channels 55a so as to maximize alignment and stability. Embodiments may include the one or more bars 40 having profiles that are, for example, flat, rectangular, square, oval, pyramidal, wedge shaped, or trapezoidal or any combination thereof. Additionally, the one or more bars 40 may include a fastening means 40c for securing the load support member 35 to the frame portion 55 once the one or more bars 40 are engaged within the plurality of channels 55a.

Returning now to FIG. 2, which details an exploded view of the load transport device 10, the one or more bars 40 have a back end 40a and an insertion end 40b. In the embodiment of the load transport device 10 of FIG. 2, the one or more bars 40 are substantially flat and have a wedge shaped profile, so that a cross section taken at the insertion end 40b is narrower than a cross section taken at the back end 40a. This wedge shaped profile of the one or more bars 40 is an example of a shape that enables alignment during engagement with the plurality of channels 55a and enables stability after engagement with a frame portion 55.

The load support member 35 may further comprise a cross member 40d from which the one or more bars 40 extend. This cross member 40d may be an integrated or selectable removable extension of the invertible shaft portion 30. In an embodiment of the load transport device 10 wherein the cross member 40d is removable, a locking mechanism (not show) may secure the cross member 40d and bars 40 of the load support member 35 to the invertible shaft 30 to provide stability. Removing the cross member 40d and attached bars 35 may allow for selectively inserting other embodiments of the bars 35 that have unique profiles and cross section shapes that integrate with particular frame portions 55 that support other types load receptacles 45 or uncontained items requiring transport. For example, an alternate cross member 40d may support thereon one or more bars 40 having a round profile for transporting one or more bicycles. As an alternate to removing the cross member 40d and attached one or more bars 40, one or more adapters (not show) may engage with the one or more bars 40 to convert their shape for another use, such as bicycle or ski transport.

In order to prevent such supporting equipment or other loose items from roadway damage, the load transport device 10 incorporates the invertible shaft 30 which enables transport of these items in a load-high position (not shown) rather than the load-low position depicted in FIGS. 1 through 4. In the load-high position, the load transport device 10 suspends items far above the roadway, thereby preventing any roadway contact and subsequent damage during transport. To understand the operation of the invertible shaft 30, an explanation of the components of the load transport device 10 is first necessary.

The channel portion 15 includes a top end 15a and a bottom end 15b with a shaft channel 15c extending therebetween along the length of the channel portion 15 and extending substantially vertically to the plane of the roadway upon which the transport vehicle travels. The invertible shaft 30 similarly has an insertion end 30a and a load lifting end 30b. The shaft channel 15c defines an interior compartment having a profile shaped to receive the profile of the invertible shaft 30. Here, in FIG. 2, the shaft channel 15c and invertible shaft 30 each have a substantially trapezoidal profile. Any profile shape is acceptable for use with the present invention, and the embodiment of FIG. 2 is shown for demonstration purposes only. The channel shaft 15c and invertible shaft 30 may have, for example, complimentary profiles that are trapezoidal, square, rectangular, triangular, oval shaped or any combination or variation thereof.

The channel portion 15 may be fitted, in one embodiment, with a pinion gear 17 that is moved by rotating an integrated hand crank 19. The pinion gear 17 functionally engages with a rack gear system 32 that is an integrated portion extending along the length of the invertible shaft 30. In an alternative embodiment, the pinion gear 17 may comprise a motorized component (not shown) for electronically powering rotation. As described above, the invertible shaft 30 may slideably engage with the channel portion 15 in one of two orientations, load-low or load-high. Inserting the insertion end 30a of the invertible shaft 30 into the bottom end 15b of the channel portion 15 results in a load-low condition, as shown in FIGS. 1 through 4. Inserting the insertion end 30a of the invertible shaft 30 into the top end 15a of the channel portion 15 results in a load-high condition with the support member 35 riding higher above the road way than at the load-low orientation. This load-high position enables secure, suspended transport of loose articles, such as bicycles, skis, kayaks and other supporting equipment unsuited for transport in a cargo container. Additionally, the one or more specific adapters (not shown) may mate with the one or more bars 40 to insure highly secure, customized transport in the load-high position.

The load transport device 10 thus enables transport of several disparate types of loads. In addition to providing this range of utility, pinion gear 17 and rack gear system 32 enable even greater height adjustment of the invertible shaft 30 when engaged within the channel portion 15. This adjustability feature makes loading and unloading equipment and paraphernalia onto and off of the load transport device 10 more ergonomic. A user need only turn the hand crank 19 clockwise or counterclockwise to lower or raise the load support member 35 to a useable height. Unlike current roof rack cargo containers and rear mounted bike racks, a user need not lift equipment overhead or beyond any safe or comfortable lifting height. Additionally, when a framed load receptacle 45 engages at a load-low position, a user may comfortably store items in the load receptacle 45 and later turn the hand crank 19 to raise the filled load receptacle 45 above the roadway. Upon arrival at a destination, a user may turn the hand crank once more to lower the load receptacle 45, which may be equipped with detachable and/or foldable wheels 60 or ski devices to assist with manual transport to an unloading area, such as a ski lodge or a campground.

Turning now to FIG. 3, an alternate embodiment of the load transport device 10 includes a protruding member 40e on each of the one or more bars 40 of the load support member 35. A load receptacle 45 comprises an integrated frame portion 55 having a plurality of channels 55a each with a receiver groove 55d therein for accommodating the protruding member 40e. Here, FIG. 3 also shows an alternate embodiment of a load receptacle 45 compatible for use with the load transport device 10. The load receptacle 45 optionally may receive one or more sports equipment inserts 125 for securing particular pieces of sports equipment, such as skis, snowboards or golf clubs. This load receptacle 45 also incorporates an integrated frame portion 55 and additionally may support an expandable, detachable bag 135, which is attachable to an open end of the load receptacle 45 to cover and protect contents. The detachable bag 135 may include a sealable opening 135a which may be opened and closed with a zipper device or a VELCRO brand hook and loop fastener assembly. In addition to receiving the detachable bag 135, the load receptacle 45 may receive a plurality of interchangeable covers including any number of snap fit or locking covers. Preferably these covers are made from a waterproof, lightweight, durable material, such as nylon, plastic or neoprene material.

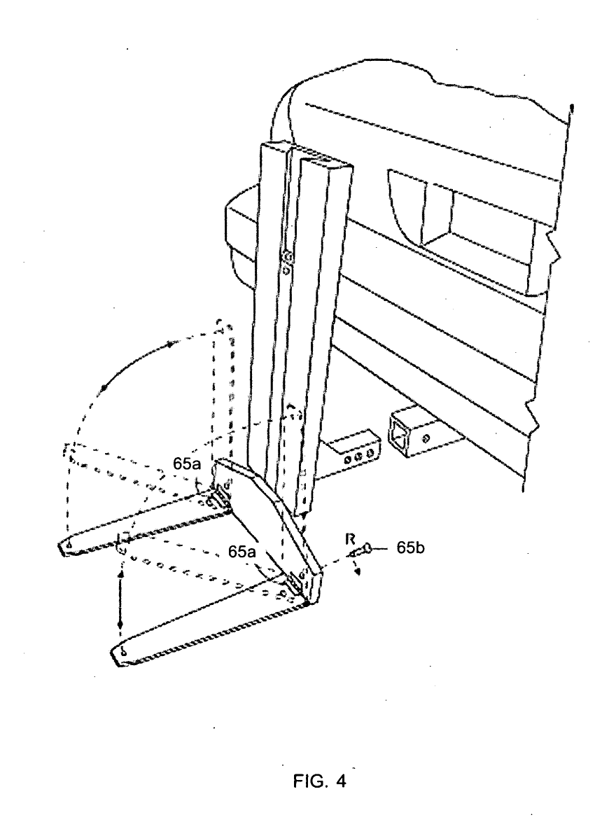

FIG. 4 discloses another embodiment of the present invention. The load transport device 10 in this embodiment includes a support member 35 having one or more bars 40 that are hingedly attached to a cross member 40d with hinges 65a. This configuration enables storing the one or more bars 40 in a streamlined position when unused. The one or more bars 40 are secured against the cross member 40d with a fastening means 65b, such as, for example, a rivet, a locking pin or a screw and nut fastening system.

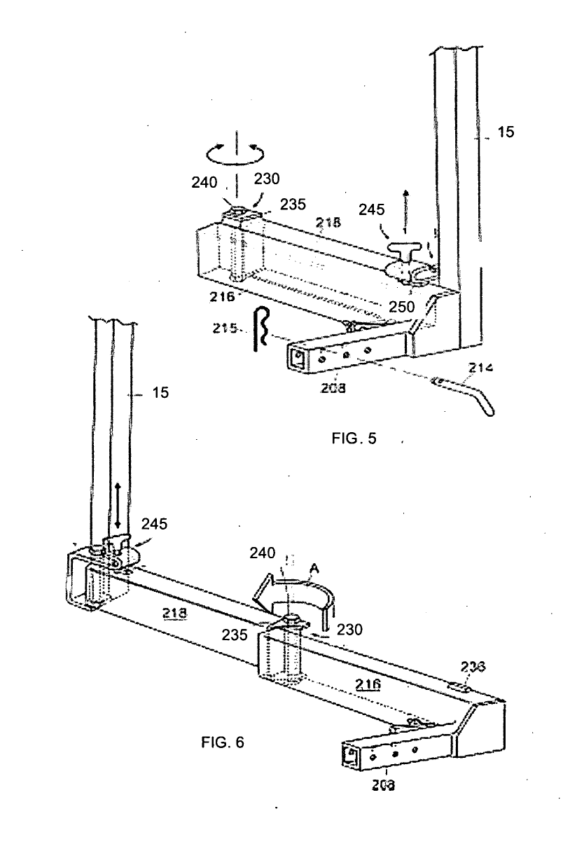

FIGS. 5 and 6 depict another feature of one embodiment of the present invention in which the channel portion 15 mounts to a swing arm assembly 200 for enabling access to a vehicle on which the load transport device 10 is mounted. The swing arm assembly 200 includes a first arm 216 and a second support arm 218. The swing arm assembly 200 has an attachment portion 208 that is adapted for mounting to the receiver portion 25 of a vehicle mounted trailer hitch. The attachment portion 208 may be fastened to the receiver portion 25 with a hitch pin 214 and hitch clip 215. Additionally, the attachment portion 208 attaches to an inside end of the first arm 216 such that the first arm 216 takes a position that is approximately parallel to the vehicle's rear bumper.

The outboard end of the first arm 216 includes a hinge assembly 230 that pivotally connects the outboard end of the first fixed arm 216 within the inboard end of the second arm 218 such that the two arms are coplanar. The inboard end of the second arm 218 is secured to the hinged pivot mechanism 235 with, for example, a bushing 235 and pinch bolt assembly 240.

The hinge pivot assembly 230 allows the second arm 218 to swing freely through an approximately 180 degree arc between a first closed position and a second extended, open position as FIGS. 5 and 6 depict respectively. A directional arrow A in FIG. 6 indicates this swinging movement. As FIG. 5 depicts, a fastener device, such as a threaded wing nut and screw assembly 245 may affix the first arm 216 to the channel portion 15 for retaining the swing arm assembly 200 in a closed and immobile position.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

I claim:

1. A load transport device adapted for mounting to a vehicle mounted trailer hitch, the load transport device comprising:
a. a channel portion fitted with a pinion gear, the channel portion being rigidly attached to a mounting bar which slideably engages a receiver portion of the trailer hitch; and
b. an invertible shaft with a rack gear system, the invertible shaft having a channel portion insertion end and a load lifting end, the invertible shaft being adapted for slideable engagement in a load-low or load-high orientation within the channel portion with functional engagement between the pinion gear and the rack gear system.

2. The load transport device of claim 1 further comprising a load support member attached to the load lifting end.

3. The load transport device of claim 2 wherein the load support member comprises one or more bars.

4. The load transport device of claim 3 wherein the one or more bars are adapted for engagement with one or more channels of a frame portion that supports a load receptacle.

5. The load transport device of claim 4 wherein the one or more bars are substantially flat.

6. The load transport device of claim 4 wherein the one or more bars are substantially pyramidal.

7. The load transport device of claim 4 wherein the frame portion further comprises a plurality of wheels.

8. The load transport device of claim 7 wherein the plurality of wheels are detachable or foldable.

9. The load transport device of claim 4 wherein the frame portion further comprises one or more detachable inserts.

10. The load transport device of claim 9 wherein the one or more detachable inserts are ski devices.

11. The load transport device of claim 1 further comprising a hand crank for manual rotation of the pinion gear.

12. The load transport device of claim 1 further comprising a motor for automated rotation of the pinion gear.

13. The load transport device of claim 2 wherein the load support member is adapted for carrying one or more bicycles.

14. The load transport device of claim 2 wherein the load support member is sized and shaped to accept conventional roof rack accessories.

15. The load transport device of claim 1 wherein the channel portion comprises a hinge and a swing arm enabling the channel portion to pivot relative to the hitch by swinging horizontally away from the hitch.

16. A method of using a load transport device adapted for mounting to a vehicle mounted trailer hitch comprising the steps of:
a. providing a channel portion fitted with a pinion gear, the channel portion being rigidly attached to a mounting bar which slideably engages a receiver portion of the trailer hitch;
b. providing an invertible shaft with a rack gear system, the invertible shaft having a channel portion insertion end and a load lifting end, the invertible shaft being adapted for slideable engagement in a load-low or load-high orientation within the channel portion with functional engagement between the pinion gear and the rack gear system;
c. engaging the channel portion with the receiver portion of the trailer hitch; and
d. slideably engaging the invertible shaft with the channel portion.

17. The method of claim 16 further comprising providing a load support member attached to the load lifting end.

18. The method of claim 17 wherein the load support member comprises one or more substantially flat bars.

19. The method of claim 17 wherein the load support member is adapted for carrying one or more bicycles.

20. The method of claim 17 wherein the load support member is sized and shaped to accept conventional roof rack accessories.
